(19) United States
(12) Patent Application Publication
(10) Pub. No.: US 2007/0148467 A1
(43) Pub. Date: Jun. 28, 2007

(54) THERMAL MANAGEMENT CIRCUIT MATERIALS, METHOD OF MANUFACTURE THEREOF, AND ARTICLES FORMED THEREFROM

(75) Inventors: Michael E. St. Lawrence, Thompson, CT (US); Murali Sethumadhavan, Shrewsbury, MA (US); Ani Shere, Chelmsford, MA (US)

Correspondence Address: CANTOR COLBURN, LLP, 55 GRIFFIN ROAD SOUTH, BLOOMFIELD, CT, 06002, US

(73) Assignee: WORLD PROPERTIES, INC., Lincolnwood, IL (US)

(21) Appl. No.: 11/614,505

(22) Filed: Dec. 21, 2006

Related U.S. Application Data
(60) Provisional application No. 60/753,523, filed on Dec. 23, 2005.

(51) Int. Cl. B32B 9/04

(52) U.S. Cl. 428/411.1

(57) ABSTRACT

A thermal management circuit material comprises an electrically conductive layer; a dielectric layer comprising a polymer matrix and a thermally conductive, electrically non-conductive particulate filler, wherein the dielectric layer is disposed on and in at least partial contact with the electrically conductive layer, and wherein the circuit material has a thermal conductivity of greater than or equal to about 1 watt per meter-degree Kelvin.

### CROSS-REFERENCE TO RELATED APPLICATION

This application claims priority to U.S. Provisional Application Ser. No. 60/753,523 filed Dec. 23, 2005, which is incorporated by reference herein in its entirety.

### BACKGROUND

This invention relates to thermal management circuit materials.

While there are a variety of circuit materials available today, there is a demand for circuit materials for high power applications, that is, applications using high operating temperature. In particular, semiconductors that are designed to carry high current loads can have an upper limit for operating temperatures, above which the semiconductor can fail, jeopardizing the operational reliability of the entire circuit. Circuit materials designed for thermal management have been used where there is a need to dissipate heat, in order to maintain the operating temperature in the desired range. Such heat dissipating thermal management circuit substrates are useful with high power components such as power amplifiers, high power diodes and transistors, and other devices for high power switching and similar applications. In such applications, a heat-generating component is affixed to a thermal management circuit material. Thermal management circuit materials typically have a patternable electrically and thermally conductive layer (typically a metal such as copper or aluminum) disposed on a dielectric layer, and a thermally conductive base layer (again, typically a metal such as copper or aluminum) on the opposite side of the dielectric layer, for conducting heat away from the component.

The dielectric layers disposed between these conductive layers can limit the thermal conductivity of the circuit material, however. Organic dielectric materials used as dielectric layers, such as epoxy glass composites, have low thermal conductivities, and can further lack the thermal stability needed for high operating temperatures, e.g., greater than 150° C. Inorganic dielectric materials have higher thermal conductivity (typically greater than or equal to about 20 Watts per meter-degree Kelvin, W/m-K), low coefficients of thermal expansion (typically less than or equal to 10 parts per million per degree centigrade, ppm/° C.), and are thermally stable (e.g., up to about 900° C.). However, such inorganic dielectric materials must be adhered to the thermally and electrically conductive layer using an adhesive, are brittle, have lower dielectric strengths, typically less than or equal to about 500 volts per mil of dielectric thickness (V/mil), and therefore must be relatively thick (greater than or equal to 10 mils/250 micrometers). This is disadvantageous for current applications, which require increasingly smaller components.

What is needed, therefore, is a thin thermal management circuit material for high power applications that have the desired thermal and electrical properties, as well as heat stability. Thus, the circuit material desirably has high thermal conductivity and low electrical conductivity, and is suitable for use in mounting electrical devices for high power applications.

### SUMMARY

The above discussed and other drawbacks and deficiencies of the prior art thermal management circuit materials can be overcome or alleviated by a circuit material comprising a conductive layer; and a dielectric layer comprising a polymer matrix and a thermally conductive, electrically non-conductive particulate filler; wherein the dielectric layer is disposed on and in at least partial contact with the conductive layer, and wherein the circuit material has a thermal conductivity of greater than or equal to about 1 W/m-K, and further wherein the dielectric layer has a coefficient of thermal expansion (CTE) of 0 to about 50 ppm/° C.

Circuits, methods of manufacture of the circuits, articles comprising the circuit material and circuit, and applications are also disclosed.

The thermal management circuit material has a desirable combination of properties including high thermal conductivity, low electrical conductivity, and high thermal and dimensional stability, wherein the combination of properties is superior to that found in comparable inorganic dielectric-based circuit materials or organic/filler based dielectric circuit materials. The materials can also be provided in thin cross-section.

The features and advantages of the present invention will be appreciated and understood by those skilled in the art from the following detailed description and drawings.

### BRIEF DESCRIPTION OF THE DRAWINGS

Referring now to the exemplary drawings wherein like elements are numbered alike in the several FIGURES:

FIG. 1 is a schematic representation of a circuit material.

FIG. 2 is a schematic representation of a circuit.

### DETAILED DESCRIPTION

It has been found by the inventors hereof that a circuit material comprising a conductive layer, a thermally conductive and electrically non-conductive dielectric layer contacted to the conductive layer, and a thermally conductive base layer contacted to the dielectric layer, has a thermal conductivity of greater than or equal to 1 W/m-K. The dielectric layer comprises a dielectric material comprising a resin and a particulate filler, where the particulate filler is present in an amount sufficient to provide both excellent thermal conductivity and a z-axis coefficient of thermal expansion of less than or equal to 25 ppm/° C. Further, the particulate fillers are of a type and amount sufficient to provide excellent thermal stability to the dielectric layer at operating temperatures of up to 165° C. or greater.

The dielectric layer used in the circuit material comprises a dielectric material comprising a resin, a particulate filler, and additional optional components including dispersing agents, plasticizers, surface modifiers, solvents, and the like.

Either thermosetting or thermoplastic resins can be used, or a combination thereof. Suitable thermosetting resin compositions useful in the polymer matrix are preferably flowable prior to cure, and substantially non-flowable after cure. Thus, suitable thermosetting resin compositions comprise a material having a viscosity effective to allow coatability of the resin onto a metal surface, and sufficient curability to form a solid dielectric substrate material. Specific useful thermosetting polymers include polyimides; epoxy resins; fluoropolymers; silicones; polyenes such as polybutadiene, polybutadiene copolymers, polyisoprene, polyisoprene copolymers, and polybutadiene-polyisoprene copolymers; and a combination comprising at least one of the foregoing. Useful thermoplastic polymers for use in the polymer matrix include polyetherimides; polyether-ether ketone (PEEK) polymers; and the like, and combinations comprising at least one of the foregoing thermoplastic polymers.

A useful thermoplastic or thermosetting resin for the polymer matrix that can be used in the dielectric layer is a polyimide. “Polyimides” as used herein can include polyetherimides and polyamide imides having about 10 to about 1,000, or more specifically about 10 to about 500 units. Polyimides can be prepared by reacting a dianhydride, e.g., an aromatic bis(anhydride) with an organic diamine in an equimolar ratio to obtain a polyamic acid, which can form the polyimide upon further curing. The reaction can be carried out at an elevated temperature, in polar solvent suitable for dissolving the dianhydride and diamine comonomers.

Illustrative examples of aromatic bis(anhydride)s that can be used in the manufacture of polyimides include pyromellitic dianhydride, 2,3,6,7-naphthalene tetracarboxylic acid dianhydride, 3,3′,4,4′-diphenyl tetracarboxylic acid dianhydride, 1,2,5,6-naphthalene tetracarboxylic acid dianhydride, 2,2′,3,3′-diphenyl tetracarboxylic acid dianhydride, 2,2-bis(3,4-dicarboxyphenyl)propane dianhydride, bis(3,4-dicarboxyphenyl)sulfone dianhydride, 3,4,3,10-perylene tetracarboxylic acid dianhydride, bis(3,4-dicarboxyphenyl)ether dianhydride, 2,2-bis(2,3-dicarboxyphenyl)propane dianhydride, 1,1-bis(2,3-dicarboxyphenyl)ethane dianhydride, bis(3,4-dicarboxyphenyl)methane dianhydride, bis(2,3-dicarboxyphenyl)sulfone dianhydride, benzophenone tetracarboxylic acid dianhydride, cyclopentane tetracarboxylic acid dianhydride, cyclohexane tetracarboxylic acid dianhydride, butane tetracarboxylic acid dianhydride, 2,2-bis[4-(3,4-dicarboxyphenoxy)phenyl]propane dianhydride, 4,4′-bis(3,4-dicarboxyphenoxy)diphenyl ether dianhydride, 4,4′-bis(3,4-dicarboxyphenoxy)diphenyl sulfide dianhydride, 4,4′-bis(3,4-dicarboxyphenoxy)benzophenone dianhydride, 4,4′-bis(3,4-dicarboxyphenoxy)diphenyl sulfone dianhydride, 2,2-bis[4-(2,3-dicarboxyphenoxy)phenyl]propane dianhydride, 4,4′-bis(2,3-dicarboxyphenoxy)diphenyl ether dianhydride, 4,4′-bis(2,3-dicarboxyphenoxy)diphenyl sulfide dianhydride, 4,4′-bis(2,3-dicarboxyphenoxy)benzophenone dianhydride, 4,4′-bis(2,3-dicarboxyphenoxy)diphenyl sulfone dianhydride, 4-(2,3-dicarboxyphenoxy)-4′-(3,4-dicarboxyphenoxy)diphenyl-2,2-propane dianhydride, 4-(2,3-dicarboxyphenoxy)-4′-(3,4-dicarboxyphenoxy)diphenyl ether dianhydride, 4-(2,3-dicarboxyphenoxy)-4′-(3,4-dicarboxyphenoxy)diphenyl sulfide dianhydride, 4-(2,3-dicarboxyphenoxy)-4′-(3,4-dicarboxyphenoxy)benzophenone dianhydride, and 4-(2,3-dicarboxyphenoxy)-4′-(3,4-dicarboxyphenoxy)diphenyl sulfone dianhydride can be used, as well as a combination comprising at least one of the foregoing dianhydrides. Specifically useful dianhydrides include pyromellitic dianhydride and benzophenone tetracarboxylic acid dianhydride.

Diamines that can be reacted with the foregoing dianhydrides to form polyimides of formula (1) include, for example, ethylenediamine, propylenediamine, trimethylenediamine, diethylenetriamine, triethylenetetramine, hexamethylenediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis(3-aminopropyl) amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, 1,4-diamino-2-phenylbenzene, 1,3-diamino-4-chlorobenzene, 3,3′-dimethoxybenzidine, m-xylenediamine, p-xylenediamine, 4,4′-diaminobiphenyl, 4,4′-diaminodiphenylmethane, 4,4′-diaminodiphenylpropane, 2,2-bis(4-aminophenyl)propane, 2,2-bis(4-aminophenyl)-1,1,1,3,3,3-hexafluoropropane, 3,4-diaminodiphenyl ether, 1,3-bis(3-aminophenoxy)benzene, 1,3-bis(4-aminophenoxy)benzene, 1,4-bis(4-aminophenoxy)benzene, 4,4′-bis(4-aminophenoxy)biphenyl, 4,4′-bis(3-aminophenoxy)biphenyl, 2,2-bis{4-(4-aminophenoxy)phenyl}propane, 2,2-bis {4-(4-aminophenoxy)phenyl}propane, 2,2-bis {4-(4-aminophenoxy)phenyl}-1,1,1,3,3,3-hexafluoropropane, 4,4′-diaminodiphenyl thioether, 4,4′-diaminodiphenyl sulfone, 4,4′-diaminodiphenyl ether, 2,2′-diaminobenzophenone, 3,3′-diaminobenzophenone, naphthalene diamines such as 1,8- and 1,5-diaminonaphthalene, heterocyclic aromatic diamines such as 2,6-diaminopyridine, 2,4-diaminopyrimidine, and 2,4-diamino-s-triazine, or siloxane-diamines such as bis(aminoalkyl)polysiloxanes, e.g., alpha, omega-(3-amino-1-propyl)polydimethylsiloxane. Mixtures comprising at least one of the foregoing diamines can also be used.

The reaction product of the dianhydride and the diamine is a polyamic acid polymer. A polyimide can be prepared from a polyamic acid polymer by heating at a temperature of about 150° C. to about 350° C., to complete the condensation to form the polyimide. Polyimide resins and polymers suitable for use herein have weight averaged molecular weights of about 2,000 to about 100,000, specifically about 3,000 to about 50,000, as determined by GPC. The polyimide polymers are flowable in a temperature range of interest for manufacture, specifically about 200° C. or less. Non-limiting examples of suitable aromatic polyimides include KAPTON® polyimide resin from General Electric or BN300 polyimide from Mitsui Chemical.

Other useful thermosetting resins for use in the polymer matrix include low molecular weight epoxy resins. Suitable epoxy resins can have weight averaged molecular weights (Mw) of about 2,000 to about 100,000, specifically about 3,000 to about 50,000, as measured, for example, by gel permeation chromatography (GPC); an epoxy equivalent weight (i.e., number averaged molecular weight per one epoxy) of from about 170 to about 2000; and a melting point below about 140° C. Combinations of epoxy resins can be used.

Specific examples of epoxy resins include epoxidized esters of polyethylenically unsaturated monocarboxylic acids, epoxidized esters of unsaturated monohydric alcohols and polycarboxylic acids, such as, for example, bis-(2,3-epoxybutyl) adipate, bis-(2,3-epxoybutyl)oxalate, bis-(2,3-epoxyhexyl)succinate, bis-(3,4-epoxybutyl)maleate, bis-(2,3-epoxyoctyl)pimelate, bis-(2,3-epoxybutyl)phthalate, bis-(2,3-epoxyoctyl)tetrahydrophthalate, bis-(4,5-epoxydodecyl)maleate, bis-(2,3-epoxybutyl)terephthalate, bis-(2,3-epoxypentyl)thiodipropionate, bis-(5,6-epoxytetradecyl)diphenyldicaboxylate, bis-(3,4-epoxyheptyl)sulfonyldibutyrate, tris-(2,3-epoxybutyl)-1,2,4-butanetricarboxylate, bis-(5,6-epoxypentadecyl)tartrate, bis-(4,5-epxoytetradecyl)maleate, bis-(2,3-epoxybutyl)azelate, bis-(3,4-epoxybutyl)citrate, bis-(5,6-epoxyoctyl)cyclohexane-1,2-dicarboxylate, and bis-(4,5-epoxyoctadecyl)malonate; epoxidized esters of unsaturated alcohols and unsaturated carboxylic acids, such as 2,3-epoxybutyl-3,4-epoxypentanoate, 3,4-epoxyhexyl, 3,4-epoxypentanoate, 3,4-epoxycyclohexyl-3,4-epoxycyclohexanoate, 3,4-epoxycyclohexyl-4,5-epoxyoctanoate, and 2,3-epoxycyclohexylmethyl epoxycyclohexane carboxylate; epoxidized derivatives of polyethylenically unsaturated polycarboxylic acids, such as dimethyl-8,9,12,13-diepoxyeicosanedioate, dibutyl-7,8,11,12-diepoxyoctadecanedioate, dioctyl-10,11-diethyl-8,9,12,13-diepoxyeicosanedioate, dihexyl-6,7,10,11-diepoxyhexadecanedioate, didecyl-9-epoxy-ethyl-10,11-epoxyoctadecanedioate, dibutyl-3-butyl-3,4,5,6-diepoxycyclohexane-1,2-dicarboxylate, dicyclohexyl-3,4,5,6-diepoxycyclohexane-1,2-dicarboxylate, dibenzyl-1,2,4,5-diepoxycyclohexane-1,2-dicarboxylate, and diethyl-5,6,10,11-diepoxyoctadecyl succinate; epoxidized polyesters obtained by reacting an unsaturated polyhydric alcohol and/or unsaturated polycarboxylic acid or anhydride groups, such as for example, the polyester obtained by reacting 8,9,12,13-eicosanedienedioic acid with ethylene glycol, the polyester obtained by reacting diethylene glycol with 2-cyclohexene-1,4-dicarboxylic acid and the like, and mixtures thereof; and epoxidized polyethylenically unsaturated hydrocarbons, such as epoxidized 2,2-bis (2-cyclohexenyl)propane, epoxidized vinyl cyclohexene and epoxidized dimer of cyclopentadiene.

Epoxidized polymers and copolymers of diolefins, such as butadiene, can also be useful. Examples of these include epoxidized unsaturated butadiene-acrylonitrile copolymers (nitrile rubbers), epoxidized unsaturated butadiene-styrene copolymers, and the like.

Other useful epoxy resins include the glycidyl ethers and particularly the glycidyl ethers of polyhydric phenols and polyhydric alcohols. The glycidyl ethers of polyhydric phenols are obtained by reacting epichlorohydrin with the desired polyhydric phenols in the presence of alkali. Others include the polyglycidyl ether of 1,1,2,2-tetrakis-(4-hydroxyphenyl)ethane (with a melting point of 85° C.), the polyglycidyl ether of 1,1,5,5-tetralis-(hydroxyphenyl)pentane, and the like, and mixtures thereof. Further examples include the glycidylated novolacs obtained by reacting epichlorohydrin with the phenolic novolac resins obtained by the condensation of formaldehyde with a molar excess of a hydroxyaromatic compound such as phenol or cresol.

Suitable curing agents for epoxy resins include, for example, amines such as imidazole, aniline, ethanolamine, diethanolamine, triethanolamine, pyridine, and the like. These amines can be present as free amines or as their acid salts, where suitable acids include mineral acids such as hydrochloric, sulfuric, nitric acids, and the like; organosulfonic acids such as toluenesulfonic, methanesulfonic, trifluoromethanesulfonic acids, and the like; and carboxylic acids such as formic, acetic, propionic, cyclohexanecarboxylic, benzoic, adipic, malonic, maleic, fumaric acids and the like. Combinations of the foregoing can be used. Anhydrides can also be used, such as maleic anhydride, itaconic anhydride, benzoic acid anhydride, acetic anhydride, adipic anhydride, combinations thereof, and the like.

Fluoropolymers can also be used as a resin in the resin composition. Examples of fluoropolymers that can be used include polytetrafluoroethylene (PTFE), perfluoropolyvinyl acetate (PFA), perfluoro polyvinyl alcohol, and the like, and a combination comprising at least one of the foregoing. In addition, copolymers such as poly(tetrafluoroethylene)-co-(trifluorovinylacetate), poly(tetrafluoroethylene)-co-(trifluorovinylalcohol), and the like, and a combination comprising at least one of the foregoing, can also be used. Where used, fluoropolymers are desirably processable such that they can be coated either as a suspension of crosslinkable particles, or as a melt, and are functionalized such that the fluoropolymer can be crosslinked using appropriate crosslink chemistry. Suitable functional groups include alcohols, phenols, amines, anhydrides, carboxylic acid derivatives, and the like. Suitable crosslinking agents for use with fluoropolymers include epoxy compounds, precursors to aromatic ethers such as 4,4′-difluorodiphenylether, 4,4′-difluorodiphenylsulfone, and bis(4,4′difluorophenyl)isopropylidene; dianhydrides such as pyromellitic dianhydride; and the like. The fluoropolymers can also be crosslinked by a free radical mechanism using pendant vinyl groups and a free radical curing agent.

Silicones can also be used as a thermosetting resin composition in the polymer matrix. Suitable silicones are derived from the reaction of an organopolysiloxane having at least two alkenyl groups per molecule and a organopolysiloxane having at least two hydrogen groups per molecule. Organopolysiloxanes having at least two alkenyl groups per molecule are generally represented by the formula:
MₐD_{b}T_{c}Q_{d},
wherein the subscripts a, b, c, and d are zero or a positive integer, subject to the limitation that if subscripts a and b are both equal to zero, subscript c is greater than or equal to two; M has the formula R₃SiO_{1/2}; D has the formula R₂SiO_{2/2}; T has the formula RSiO_{3/2}; and Q has the formula SiO_{4/2}, wherein each R group independently represents alkenyl groups, substituted and unsubstituted monovalent hydrocarbon groups having from one to forty, specifically one to six carbon atoms each, subject to the limitation that at least two of the R groups are alkenyl groups. Suitable alkenyl R-groups are exemplified by vinyl, allyl, butenyl, pentenyl, hexenyl, and heptenyl, with vinyl being particularly useful. The alkenyl group can be bonded at the molecular chain terminals, in pendant positions on the molecular chain, or both.

Other silicon-bonded organic groups in the organopolysiloxane having at least two alkenyl groups, when present, are exemplified by alkyl groups such as methyl, ethyl, propyl, butyl, pentyl, and hexyl; aryl groups such as phenyl, tolyl, and xylyl; arylalkyl groups such as benzyl and phenethyl; and halogenated alkyl groups such as 3-chloropropyl and 3,3,3-trifluoropropyl. Methyl and phenyl are specifically useful.

The alkenyl-containing organopolysiloxane can have straight chain, partially branched straight chain, branched-chain, or network molecular structure, or can be a mixture of such structures. The alkenyl-containing organopolysiloxane is exemplified by trimethylsiloxy-endblocked dimethylsiloxane-methylvinylsiloxane copolymers; trimethylsiloxy-endblocked methylvinylsiloxane-methylphenylsiloxane copolymers; trimethylsiloxy-endblocked dimethylsiloxane-methylvinylsiloxane-methylphenylsiloxane copolymers; dimethylvinylsiloxy-endblocked dimethylpolysiloxanes; dimethylvinylsiloxy-endblocked methylvinylpolysiloxanes; dimethylvinylsiloxy-endblocked methylvinylphenylsiloxanes; dimethylvinylsiloxy-endblocked dimethylvinylsiloxane-methylvinylsiloxane copolymers; dimethylvinylsiloxy-endblocked dimethylsiloxane-methylphenylsiloxane copolymers; dimethylvinylsiloxy-endblocked dimethylsiloxane-diphenylsiloxane copolymers; and mixtures comprising at least one of the foregoing organopolysiloxanes.

A suitable organopolysiloxane having at least two silicon-bonded hydrogen atoms per molecule is generally represented by the formula:
M′ₐD′_{b}T′_{c}Q′_{d},
wherein the subscripts a, b, c, and d are zero or a positive integer, subject to the limitation that if subscripts a and b are both equal to zero, subscript c is greater than or equal to two; M′ has the formula R′₃SiO/_{1/2}; D′ has the formula R′₂SiO_{2/2}; T′ has the formula R′SiO_{3/2}; and Q′ has the formula SiO_{4/2}, wherein each R′ group independently represents hydrogen, substituted and unsubstituted monovalent hydrocarbon groups having from one to forty, specifically one to six carbon atoms each, subject to the limitation that at least two of the R′ groups are hydrogen. Specifically, each of the R′ groups of the organopolysiloxane having at least two silicon-bonded hydrogen atoms per molecule are independently selected from hydrogen, methyl, ethyl, propyl, butyl, pentyl, hexyl, aryl, phenyl, tolyl, xylyl, arylalkyl, benzyl, phenethyl, halogenated alkyl, 3-chloropropyl, 3,3,3-trifluoropropyl, and combinations comprising at least one of the foregoing. Methyl and phenyl are specifically preferred.

The hydrogen can be bonded at the molecular chain terminals, in pendant positions on the molecular chain, or both. The hydrogen-containing organopolysiloxane component can have straight chain, partially branched straight chain, branched-chain, cyclic, or network molecular structure, or can be a mixture of two or more selections from organopolysiloxanes with the exemplified molecular structures.

The hydrogen-containing organopolysiloxane is exemplified by trimethylsiloxy-endblocked methylhydrogenpolysiloxanes; trimethylsiloxy-endblocked dimethylsiloxane-methylhydrogensiloxane copolymers; trimethylsiloxy-endblocked methylhydrogensiloxane-methylphenylsiloxane copolymers; trimethylsiloxy-endblocked dimethylsiloxane-methylhydrogensiloxane-methylphenylsiloxane copolymers; dimethylhydrogensiloxy-endblocked dimethylpolysiloxanes; dimethylhydrogensiloxy-endblocked methylhydrogenpolysiloxanes; dimethylhydrogensiloxy-endblocked dimethylsiloxanes-methylhydrogensiloxane copolymers; dimethylhydrogensiloxy-endblocked dimethylsiloxane-methylphenylsiloxane copolymers; and dimethylhydrogensiloxy-endblocked methylphenylpolysiloxanes.

The hydrogen-containing organopolysiloxane component is used in an amount sufficient to cure the composition, specifically in a quantity that provides from about 1.0 to about 10 silicon-bonded hydrogen atoms per alkenyl group in the alkenyl-containing organopolysiloxane. When the number of silicon-bonded hydrogen atoms per alkenyl group exceeds 10, foam can be produced during cure and for the heat resistance of the resulting cured silicone can progressively decline.

The silicone composition further comprises, generally as a component of the part containing the organopolysiloxane having at least two alkenyl groups per molecule, a hydrosilylation-reaction catalyst. Effective catalysts promote the addition of silicon-bonded hydrogen onto alkenyl multiple bonds to accelerate the cure. Such catalyst can include a noble metal, such as, for example, platinum, rhodium, palladium, ruthenium, iridium, or a combination comprising at least one of the foregoing. The catalyst can also include a support material, specifically activated carbon, aluminum oxide, silicon dioxide, thermoplastic resin, and combinations comprising at least one of the foregoing.

Platinum and platinum compounds known as hydrosilylation-reaction catalysts are preferred, and include, for example platinum black, platinum-on-alumina powder, platinum-on-silica powder, platinum-on-carbon powder, chloroplatinic acid, alcohol solutions of chloroplatinic acid platinum-olefm complexes, platinum-alkenylsiloxane complexes and the catalysts afforded by the microparticulation of the dispersion of a platinum addition-reaction catalyst, as described above, in a thermoplastic resin such as methyl methacrylate, polycarbonate, polystyrene, silicone, and the like. Mixtures of catalysts can also be used.

A quantity of catalyst effective to cure the present composition is used, generally from about 0.1 to about 1,000 parts per million by weight (ppm) of metal (e.g., platinum) based on the combined amounts of the reactive organopolysiloxane components.

Another useful type of thermosetting resin for use in the polymer matrix is a thermosetting polybutadiene and/or polyisoprene resin. As used herein, the term “thermosetting polybutadiene and/or polyisoprene resin” includes homopolymers and copolymers comprising units derived from butadiene, isoprene, or mixtures thereof. Units derived from other copolymerizable monomers can also be present in the resin, for example in the form of grafts. Exemplary copolymerizable monomers include but are not limited to vinylaromatic monomers, for example substituted and unsubstituted monovinylaromatic monomers such as styrene, 3-methylstyrene, 3,5-diethylstyrene, 4-n-propylstyrene, alpha-methylstyrene, alpha-methyl vinyltoluene, para-hydroxystyrene, para-methoxystyrene, alpha-chlorostyrene, alpha-bromostyrene, dichlorostyrene, dibromostyrene, tetra-chlorostyrene, and the like; and substituted and unsubstituted divinylaromatic monomers such as divinylbenzene, divinyltoluene, and the like. Combinations comprising at least one of the foregoing copolymerizable monomers can also be used. Exemplary thermosetting polybutadiene and/or polyisoprene resin include but are not limited to butadiene homopolymers, isoprene homopolymers, butadiene-vinylaromatic copolymers such as butadiene-styrene, isoprene-vinylaromatic copolymers such as isoprene-styrene copolymers, and the like.

The thermosetting polybutadiene and/or polyisoprene resins can also be modified, for example the resins can be hydroxyl-terminated, methacrylate-terminated, carboxylate-terminated resins. Post-reacted resins can be used, such as such as epoxy-, maleic anhydride-, or urethane-modified butadiene or isoprene resins. The resins can also be crosslinked, for example by divinylaromatic compounds such as divinyl benzene, e.g., a polybutadiene-styrene crosslinked with divinyl benzene. Suitable resins are broadly classified as “polybutadienes” by their manufacturers, for example Nippon Soda and Sartomer Inc. Mixtures of resins can also be used, for example, a mixture of a polybutadiene homopolymer and a poly(butadiene-isoprene) copolymer. Combinations comprising a syndiotactic polybutadiene can also be useful.

The thermosetting polybutadiene and/or polyisoprene resin can be liquid or solid at room temperature, with liquid resins preferred, in order to provide a viscosity suitable for vacuum-pressure impregnation (VPI). Suitable liquid resins can have a number average molecular weight greater than about 5,000, but generally have a number average molecular weight of less than about 5,000 (most preferably about 1,000 to about 3,000). Thermosetting polybutadiene and/or polyisoprene resins having at least 90 wt % 1,2 addition are preferred because they exhibit the greatest crosslink density upon cure, due to the large number of pendent vinyl groups available for crosslinking.

The polybutadiene and/or polyisoprene resin is present in the resin system in an amount of up to about 60 wt. % with respect to the total resin system, more specifically about 10 to about 55 wt. %, even more specifically about 15 to about 45 wt %.

Other polymers that can co-cure with the thermosetting polybutadiene and/or polyisoprene resins can be added for specific property or processing modifications. For example, in order to improve the stability of the dielectric strength and mechanical properties of the electrical substrate material over time, a lower molecular weight ethylene propylene elastomer can be used in the resin systems. An ethylene propylene elastomer as used herein is a copolymer, terpolymer, or other polymer comprising primarily ethylene and propylene. Ethylene propylene elastomers can be further classified as EPM copolymers (i.e., copolymers of ethylene and propylene monomers), or EPDM terpolymers (i.e., terpolymers of ethylene, propylene, and diene monomers). Ethylene propylene diene terpolymer rubbers, in particular, have saturated main chains, with unsaturation available off the main chain for facile cross-linking. Liquid ethylene propylene diene terpolymer rubbers in which the diene is dicyclopentadiene are preferred.

Useful molecular weights of the ethylene propylene rubbers are less than 10,000 viscosity average molecular weight. Suitable ethylene propylene rubbers include an ethylene propylene rubber having a viscosity average molecular weight (Mv) of about 7,200, which is available from Uniroyal under the trade name Trilene® CP80; a liquid ethylene propylene dicyclopentadiene terpolymer rubbers having a molecular weight of about 7,000, which is available from Uniroyal under the trade name of Trilene® 65; and a liquid ethylene propylene ethylidene norbornene terpolymer, having a molecular weight of about 7500, available from Uniroyal under the name Trilene® 67.

The ethylene propylene rubber is preferably present in an amount effective to maintain the stability of the properties of the substrate material over time, in particular the dielectric strength and mechanical properties. Typically, such amounts are up to about 20 wt % with respect to the total weight of the resin system, more specifically about 4 to about 20 wt. %, even more specifically about 6 to about 12 wt. %.

Another type of co-curable polymer is an unsaturated polybutadiene- or polyisoprene-containing elastomer. This component can be a random or block copolymer of primarily 1,3-addition butadiene or isoprene with an ethylenically unsaturated monomer, for example a vinylaromatic compound such as styrene or alpha-methyl styrene, an acrylate or methacrylate such a methyl methacrylate, or acrylonitrile. The elastomer is preferably a solid, thermoplastic elastomer comprising a linear or graft-type block copolymer having a polybutadiene or polyisoprene block, and a thermoplastic block that preferably is derived from a monovinylaromatic monomer such as styrene or alpha-methyl styrene. Suitable block copolymers of this type include styrene-butadiene-styrene triblock copolymers, for example those available from Dexco Polymers, Houston, Tex. under the trade name Vector® 8508M, from Enichem Elastomers America, Houston, Tex. under the trade name Sol-T-6302, and those from Fina Oil and Chemical Company, Dallas, Tex. under the trade name Finaprene® 401; styrene-butadiene diblock copolymers; and mixed triblock and diblock copolymers containing styrene and butadiene, for example those available from Shell Chemical Corporation under the trade name Kraton® D1118X. Kraton® D1118X is a mixed diblock/triblock styrene and butadiene containing copolymer, containing 30 vol. % styrene.

The optional polybutadiene- or polyisoprene-containing elastomer can further comprise a second block copolymer similar to that described above, except that the polybutadiene or polyisoprene block is hydrogenated, thereby forming a polyethylene block (in the case of polybutadiene) or an ethylene-propylene copolymer block (in the case of polyisoprene). When used in conjunction with the above-described copolymer, at materials with greater toughness can be produced. An exemplary second block copolymer of this type is Kraton® GX1855 (commercially available from Shell Chemical Corp.), which is believed to be a mixture of a styrene-high 1,2-butadiene-styrene block copolymer and a styrene-(ethylene-propylene)-styrene block copolymer.

Typically, the unsaturated polybutadiene- or polyisoprene-containing elastomer component is present in the resin system in an amount of about 10 to about 60 wt. % with respect to the total resin system, more specifically about 20 to about 50 wt. %, even more specifically about 25 to about 40 wt %.

Still other co-curable polymers that can be added for specific property or processing modifications include, but are not limited to, homopolymers or copolymers of ethylene such as polyethylene and ethylene oxide copolymers; natural rubber; norbornene polymers such as polydicyclopentadiene; hydrogenated styrene-isoprene-styrene copolymers and butadiene-acrylonitrile copolymers; unsaturated polyesters; and the like. Levels of these copolymers are generally less than 50 vol. % of the total resin system.

Free radical-curable monomers can also be added for specific property or processing modifications, for example to increase the crosslink density of the resin system after cure. Exemplary monomers that can be suitable crosslinking agents include, for example, di, tri-, or higher ethylenically unsaturated monomers such as divinyl benzene, triallyl cyanurate, diallyl phthalate, and multifunctional acrylate monomers (e.g., Sartomer resins available from Arco Specialty Chemicals Co.), or combinations thereof, all of which are commercially available. The crosslinking agent, when used, is present in resin system in an amount of up to about 20 vol. %, based on the total weight of the resin.

A curing agent can be added to the resin system to accelerate the curing reaction of the polyenes having olefinic reactive sites. Specifically useful curing agents are organic peroxides such as, dicumyl peroxide, t-butyl perbenzoate, 2,5-dimethyl-2,5-di(t-butyl peroxy)hexane, α,α-di-bis(t-butyl peroxy)diisopropylbenzene, and 2,5-dimethyl-2,5-di(t-butyl peroxy) hexyne-3, all of which are commercially available. They can be used alone or in combination. Typical amounts of curing agent are from about 1.5 wt % to about 10 wt % of the total resin composition.

A class of suitable thermoplastic resins for use in the polymer matrix includes polyether ether ketones (PEEK), which can be used in the dielectric layer. Polyether-ether ketones are linear aromatic crystalline thermoplastics have high chemical resistance and are resistant to hydrolysis with low moisture uptake. In addition, PEEK polymers have high melting points of up to temperatures of 330° C., and can be used continuously at temperatures of up to 260° C. PEEK polymers are typically derived from aromatic precursors including aromatic diols and halogen derivatives of bisaryl ketones. The polyether linkages in PEEK polymers can be formed using either electrophilic or nucleophilic aromatic substitution processes. Typically, polyether ether ketones are formed by the base catalyzed nucleophilic aromatic substitution of a bis 4-fluoroaryl ketone by a suitable aromatic dihydroxy compound, in the presence of potassium carbonate and a high boiling solvent such as diphenyl ether.

Examples of suitable bis-halogenaryl ketones include bis (4-fluorophenyl)ketone (4,4α-difluorodiphenyl ketone), bis (4-fluorophenyl)ketone, bis (4-fluoro-3-methylphenyl)ketone, bis (4-fluoro-2,5-dimethylphenyl)ketone, bis (4-fluoro-3,5-dimethylphenyl)ketone, bis (4-fluoro-2-ethylphenyl)ketone, his (4-fluoro-3-ethylphenyl)ketone, bis (4-fluoro-3-propylphenyl)ketone, bis (4-fluoro-3-butylphenyl)ketone, his ((4-fluorophenyl)(phenyl)ketone), and the like, and a combination comprising at least one of the foregoing. Examples of the aromatic diol include, for example, 4,4′-dihydroxydiphenyl, 3,3′-dihydroxydiphenyl, 4,4′-dihydroxytriphenyl, hydroquinone, resorcinol, 2,6-naphthalenediol, 4,4′-dihydroxydiphenyl ether, bis(4-hydroxyphenoxy)ethane, 3,3′-dihydroxydiphenyl ether, 1,6-naphthalenediol, 2,2-bis(4-hydroxyphenyl)propane, and bis(4-hydroxyphenyl)methane; and alkyl-, alkoxy- and halogen-substituted derivatives of the aromatic diols, such as chlorohydroquinone, methylhydroquinone, t-butylhydroquinone, phenylhydroquinone, methoxyhydroquinone, phenoxyhydroquinone, 4-chlororesorcinol, and 4-methylresorcinol. In an exemplary embodiment, a typical PEEK structure is prepared from the condensation of 4,4′-dihydroxydiphenyl ether and 4,4′-difluorodiphenyl ketone. Examples of polyether ether ketone polymers that can be suitable for use herein include those available under the trade names VIVTREX® from ICI polymers, KADEL® from Amoco Chemicals, PEIK from DuPont, and ULTRAPAK® from BASF.

In addition to the polymer matrix, the dielectric material further comprises particulate filler. Useful particulate fillers are those having high thermal conductivity and low electrical conductivity, each of which is desirable in a thermally conductive dielectric film. Suitable particulate fillers include particles of boron nitride, aluminum nitride, alumina (i.e., aluminum oxide), silicon carbide, zinc oxide, silicon nitride, titanium dioxide, magnesium oxide, aluminum silicate, carbon fibers, carbon nanotubes, beryllium oxide, diamond, or a combination comprising at least one of the foregoing. In addition, specifically useful particulate fillers include plate-type particulate fillers, which can be regular in shape, such as hexagonal or other polyhedral shapes; or irregular in shape with uneven dimensions and/or irregular edges and/or thicknesses. Where fibrous materials are used, the fibers can be present either as loose fibers, or in the form of a woven or non-woven mat. The dimensional ratio for the plate type particulate fillers is typically greater than or equal to about 3:1 between the largest and smallest dimensions, specifically greater than or equal to about 5:1, and more specifically greater than or equal to about 10:1. The largest dimension so defined for a plate type filler can also be referred to as the diameter of the particle. Plate-type particulate fillers, with their regular polyhedral structures, are useful for reducing the coefficient of thermal expansion of a composite made using these fillers. An illustrative example of a plate-type particulate filler is boron nitride, available as Carbo-Therm® Boron Nitride from Saint-Gobain. In addition, fillers having high thermal conductivity are specifically useful for increasing the thermal conductivity of a composite. An illustrative example of a particulate filler comprising a material having high thermal conductivity is aluminum nitride (AlN), available from H. C. Starck.

In an embodiment, the particulate filler has a thermal conductivity of greater than or equal to 1 W/m-K, specifically greater than or equal to 4 W/m-K, more specifically greater than or equal to 10 W/m-K, and still more specifically greater than or equal to 20 W/m-K. Also, in an embodiment, the particulate filler has a thermal conductivity less than or equal to 500 W/m-K, specifically less than or equal to 400 W/m-K, more specifically less than or equal to 300 W/m-K, and still more specifically less than or equal to 200 W/m-K.

Individual particulate fillers can thus have specific desirable physical properties, but cannot impart all of the desired physical properties to the dielectric material when used singly and in the absence of other particulate fillers. It has been found that a mixture of particulate fillers, each of which is selected for its complementary physical properties, can impart a useful combination of desirable physical properties to an organic dielectric material. In an exemplary embodiment, the particulate filler is a combination of boron nitride and aluminum nitride. Advantageously, such blends of fillers have been found to possess anisotropic thermal conductive properties, and it is therefore desirable to use a mixture of two or more fillers, each of which can have one or more useful physical properties. The types and proportions of particulate fillers that can be determined by one skilled in the art, and is based on the combination of physical properties desired in the dielectric material, and that is provided by the specific combination of particulate fillers used.

In an embodiment, the particulate filler comprises a combination of boron nitride and aluminum nitride fillers. The boron nitride and the aluminum nitride are respectively present in the particulate filler in a weight ratio of 1:99 to 99:1, specifically 10:90 to 90:10, and still more specifically 25:75 to 75:25. In a further embodiment, the particulate filler comprises an additional particulate filler selected from the particulate fillers described hereinabove. In a further specific embodiment, the additional particulate filler is alumina.

Particulate fillers, including plate-type fillers, have a distribution of particle sizes that can be described by a minimum and a maximum particle diameter. The minimum particle diameter is described by the lower detection limit of the method used to determine particle diameter, and corresponds to it. A typical method of determining particle diameters is laser light scattering, which can for example have a lower detection limit for particle diameter of 0.6 nanometers. It should be noted that particles having a diameter less than the lower detection limit can be present but not observable by the method. The maximum particle diameter is typically less than the upper detection limit of the method, and can be less than or equal to about 1,000 micrometers, specifically less than or equal to about 750 micrometers, and more specifically less than or equal to about 500 micrometers. The distribution of particle diameters can be unimodal, bimodal, or multimodal, but can be described generally using the mean of the distribution of the particle diameters, also referred to as the mean diameter. Specifically, particles of particulate filler suitable for use herein have a mean diameter (measured using an average of the particles longest dimension) of about 0.001 to about 100 micrometers, specifically about 0.1 to about 50 micrometers, more specifically about 1 to about 25 micrometers, and still more specifically about 2 to about 10 micrometers.

Combinations of such particulate filler sizes, as described by mean diameter, can also be used, where a balance of mean diameters for a specific particulate filler, and for different particulate fillers, can provide a net combination that can further improve the overall properties of an organic dielectric material comprising the combination of fillers. Such combinations can be determined by one skilled in the art according to the desired properties of the organic dielectric material.

The quantity of particulate filler is typically from about 2 to about 65 volume percent of particulate filler to resin film volume. Particulate filler particles can have an optimum size distribution based at least in part upon achieving a desired packing density for the solid particles. Packing density can contribute to enhanced thermal conductivity by maximizing the contact between particles of high thermal conductivity. A range of filler particle sizes to achieve optimal packing density can be used, depending on the desired dielectric constant, the presence of other fillers, and like considerations.

Desirable physical properties of the dielectric material that can be so affected by selection of the type and size distribution of the particulate fillers include, but are not limited to, such physical properties as thermal conductivity, coefficient of thermal expansion, dielectric strength, and thermal stability. In addition, the total amount, the particle size, and the physical properties of the particulate fillers can be selected such that the dielectric film remains processable under the desired manufacturing conditions, which includes such parameters as coating or deposition methods, curing times and temperatures, and other curing conditions such as curing atmosphere and any other physical or chemical treatments during curing.

To improve adhesion between the particulate fillers and the polymer matrix, coupling agents, e.g., silanes can be used. It has been observed that use of coupling agents significantly improves the copper peel strength of the dielectric substrate, particularly at high temperature. This is of importance in “reworking,” that is, removal and replacement of defective soldered components and devices. Poor copper peel strength at elevated temperatures can result in a damaged circuit board during rework, resulting in waste. Useful coupling agents include those capable of adhering to both the surface of the particulate filler and the polymer matrix. Examples include various compounds comprising chromium, silicon, titanium, or zirconium, and mixtures comprising at least one of the foregoing compounds. A useful chromium-containing adhesion promoter is chromium (III) methacrylate/polyvinyl alcohol solution, which is used to improve bonding between thermoset resins and hydrophilic surfaces.

Useful compounds comprising titanium include, but are not limited to, monoalkoxy titanates such as tetra-n-butoxy titanium, isopropyl tri(N-ethylamino)titanate, isopropyl tri-isostearoyl titanate and titanium di(dioctylpyrophosphate)oxyacetate; coordinate titanates such as tetraisopropyl di(dioctylphosphito)titanate; and neoalkoxy titanates such as neoalkoxy tris(dodecanoyl)benzenes sulfonyl zirconate, neoalkoxy tri(p-N-(beta-aminoethyl)aminophenyl)titanate. Other types include chelate, quaternary, and cycloheteroatom titanates. Useful compounds comprising zirconium include, but are not limited to, neoalkoxy zirconates such as neoalkoxy trisneodecanoyl zirconate, neoalkoxy tris(dodecanoyl)benzene sulfonyl zirconate, neoalkoxy tris(m-aminophenyl)zirconate, ammonium zirconium carbonate and zirconium propionate.

Useful compounds comprising silicon include a wide variety of silanes, including halosilanes, aminoalkoxysilanes, aminophenylsilanes, phenylsilanes, heterocyclic silanes, N-heterocyclic silanes, acrylic silanes, and mercapto silanes. In one embodiment, the adhesion promoter can be an epoxy silane, an acrylic silane, an aminosilane, a mercaptosilane, a vinyl silane, or a bis-silane. Other useful silanes include polymeric types, such as trimethoxy-, triacetoxy-, or triethoxysilyl modified poly-1,2-butadiene, or aminoalkyl silsequioxanes wherein the alkyl group has two to about ten carbons, for example gamma-aminopropylsilsesquioxane, available under the trade name Silquest A-1106 from OSi Specialties, Inc.

The coupling agents can be used singly or in combination. A specific coupling agent is Silquest A-1170 or Silquest A-174. In practice, the coupling agents (in an optional solvent) are applied to the particulate filler(s) before combination with the polymer matrix, although a mixture of polymer matrix and filler can be treated with the coupling agent. The choice of coating method is not critical and generally depends on the scale of the preparation. The amount of coupling agent applied to the particulate filler depends on the type of agent, the type of filler, the type of polymer matrix, and like considerations. In general, where used, the coupling agent is applied to the particulate filler so as to result in an amount of about 0.001 to about 10 weight percent, specifically about 0.01 to about 1.0 weight percent, of the weight of the particulate filler.

The relative amounts of polymer matrix (and optional additives such as crosslinking agents, curing agents, flame retardants, and the like, if present), and particulate filler can vary depending on the desired properties of the dielectric substrate. In general, the dielectric substrates can comprise, based on the total weight of the dielectric substrate, about 1 to about 95 wt %, specifically about 5 to about 90 wt %, and more specifically about 10 to about 85 wt % of polymer matrix; and about 5 to about 99 wt %, specifically about 10 to about 95 wt %, and more specifically about 15 to about 90 wt %, of particulate filler, based on the total weight of polymer matrix and particulate filler.

A dielectric layer comprising a dielectric material comprising the polymer matrix and particulate filler has a thiclmess of about 0.04 mils to about 10 mils (about 1 to about 250 micrometers), specifically about 0.06 to about 8 mils (about 1.5 to about 200 micrometers), and more specifically about 0.08 to about 7 mils (about 2 to about 180 micrometers).

The dielectric material must have resistance to chemicals encountered in printed circuit processes, as well as resistance to mechanical failures that can be caused by cutting, molding, broaching, coining or folding, which can result in damage such as cutting, ripping, cracking, or puncturing of one or more layers. The mechanical and electrical properties of the circuit material desirable provide an electrical mount that can withstand the processing conditions expected during subsequent assembly and during functional operation of the end product. For example, the circuit material must withstand exposure to chemicals encountered during printed circuit fabrication. The finished product must be mechanically durable enough to withstand mounting techniques including screws and other conventional mounting methods.

Surprisingly, it has been found that a dielectric material comprising a combination of a thermally stable polymer matrix having a combination of plate-type boron nitride filler and aluminum nitride filler can, when disposed between and in at least partial contact with a conductive layer and a metallic substrate layer, form a circuit material suitable for use as a thermally conductive base. The thermally conductive circuit material has a desirable combination of properties including high thermal conductivity, low electrical conductivity, and high thermal and dimensional stability, wherein the combination of properties is superior to that found in comparable inorganic dielectric-based circuit materials or organic/filler based dielectric circuit materials. The polymer matrix used to form the dielectric material has good adhesion to the adjacent metal layer and thermally conductive base layer, and thus the circuit substrate is prepared efficiently using these components with no need for other intervening adhesive layers that are detrimental because such layers increase the thermal resistance of the said circuit material. The thermal conductivity of the dielectric material is comparable to or greater than that of other conductive resin composite dielectric materials prepared using other thermally conductive dielectric fillers, and is at least greater than or equal to about 1 W/m-K. The dielectric strength of the dielectric material and the circuit material prepared therefrom is greater than or equal to 1,000 Volts per mil of thickness, and the thermal stability of the composition is greater than or equal to 150° C. In addition, the coefficient of thermal expansion for the circuit material is less than or equal to about 50 ppm/° C.

In an embodiment, the dielectric material has a thermal conductivity of greater than or equal to 1 W/m-K, specifically greater than or equal to 2 W/m-K, more specifically greater than or equal to 3 W/m-K, and still more specifically greater than or equal to 3.5 W/m-K. Also, in an embodiment, the dielectric material has a thermal conductivity less than or equal to 10 W/m-K, specifically less than or equal to 9 W/m-K, more specifically less than or equal to 8 W/m-K, and still more specifically less than or equal to 6 W/m-K.

In an embodiment, the dielectric material has a thermal impedance of less than or equal to 2 mil per W/m-K (0.51 cm² K/W), specifically less than or equal to 1.4 mil per W/m-K (0.35 cm²K/W), more specifically less than or equal to 1 mil per W/m-K (0.25 cm² K/W), and still more specifically less than or equal to 0.8 mil per W/m-K (0.20 cm² K/W). Also, the dielectric material has a thermal impedance of greater than or equal to 0 mil per W/m-K (0 cm²K/W), specifically greater than or equal to 0.001 mil per W/m-K (0.00025 cm²K/W), more specifically greater than or equal to 0.01 mil per W/m-K (0.0025 cm²K/W), and still more specifically greater than or equal to 0.1 mil per W/m-K (0.025 cm K/W).

In an embodiment, the dielectric material is thermally stable at a temperature of greater than or equal to 150° C., specifically greater than or equal to 165° C., more specifically greater than or equal to 180° C., still more specifically greater than or equal to 200° C., and still more specifically greater than or equal to 220° C.

The CTE of the dielectric material is desirably as low as possible. In addition to other benefits in thermal conductivity, low CTE places less strain on a circuit material prepared using the dielectric material during high temperature operation, where the CTE is more closely matched to that of the conductive layer and the thermally conductive base layer. Matching of CTE's between layers is useful to prevent cracking, delamination, and failure of the circuit substrate during operation by adhesion failure. Typically, organic dielectric materials can have high CTE's of about 25 to about 65 ppm/° C., which is significantly higher on average than that of the adjacent metal layers.

Thus, in an embodiment, the dielectric material has a CTE of less than or equal to 50 ppm/° C., specifically less than or equal to 25 ppm/° C., more specifically less than 20 ppm/° C., still more specifically less than or equal to 15 ppm/° C., and still more specifically less than or equal to 12 ppm/° C. Also, the dielectric material has a CTE of greater than 0 ppm/° C., specifically greater than or equal to 1 ppm/° C., more specifically greater than or equal to 2 ppm/° C., still more specifically greater than or equal to 3 ppm/° C., and still more specifically greater than or equal to 4 ppm/° C.

In general, the dielectric layer is prepared from a dielectric composition as follows. A thermoplastic resin or thermosetting resin composition and any optional components, e.g. dispersing agents, coupling agents, crosslinkers, plasticizers, curing agents, or the like, are thoroughly mixed to form an intimate blend in conventional mixing equipment, in either the presence or the absence of a solvent. The mixing temperature is regulated to avoid substantial decomposition, crosslinking, or other reaction of the components. Where thermoplastic resins are used, mixing can occur in the melt or in solution in an appropriate solvent. Mixing continues until the components are uniformly dispersed throughout to form the dielectric composition. The filler can be dispersed in the resin using conventional dispersing equipment. The dispersing process can be done in stages involving different or the same dispersing equipment to incrementally increase the quality of dispersion.

Where a thermosetting resin composition is used in the dielectric composition, the dielectric layer can be applied in an uncured or partially cured state. In one embodiment, the dielectric material is not cured (i.e., is A-staged) after application and during and after contacting of the thermally conductive base layer. In another embodiment, the dielectric layer is partially cured, i.e., “B-staged,” after application but prior to further processing. In another embodiment, the dielectric layer is fully cured after application (“C-staged”), but prior to further processing. Cure can be effected by exposure to radiation, e.g. UV radiation, heat, or a combination comprising at least one of these, depending on the resin and curing mechanism used. Effective cure temperatures for many thermosetting resin compositions can be about 200 to about 350° C., specifically about 220 to about 320° C., more specifically about 250 to about 280° C.

The dielectric layer can be subjected to a variety of processing steps known for the production of circuit materials before or after deposition on the electrically conductive layer. Other layers can be added, for example using by lamination, such as roll-to-roll lamination, coextrusion, calendaring, and the like. Where lamination or rolling is used, the layering is preferably at a temperature of about 10° C. less than the melting point of the resin. Composites used in circuit materials can also be annealed to reduce or remove mechanical stresses contained within the films. Curing and/or annealing can be carried out before or after layering.

The dielectric strength of the dielectric layer (and hence the circuit material) can be determined by measuring the dielectric breakdown voltage at multiple points on a sample, which is done by applying a voltage across two electrodes in intimate contact with surfaces of the dielectric material opposite each other, such that the electrodes are separated by a distance equal to the thickness of the dielectric substrate at the point of measurement. A direct current potential is placed across the electrodes, and the resistance to the voltage flow is measured as the voltage is increased. The voltage at which current begins to flow between the electrodes is noted as the dielectric breakdown voltage, and is measured in volts per mil of thickness (V/mil). Different dielectric breakdown voltages are associated with different materials of construction, and can vary depending on the composition of the dielectric layer, including the resin used, the type and amount of particulate filler or other additives, and other compositional factors. The level of electrically conducting contaminants in the dielectric material can also be a factor. Contaminants affecting dielectric breakdown voltage can include the amount of absorbed moisture in the dielectric, ionic contaminants including inorganic contaminants present in the dielectric layer, conductive impurities in the particulate filler, and the like. The degree of cure of the dielectric substrate can have an effect, with fully cured dielectric substrate having a higher dielectric breakdown voltage. Thickness uniformity also affects the dielectric breakdown voltage, with thinner regions showing lower dielectric breakdown voltages. Thus, in an embodiment, the dielectric strength of a circuit material comprising the dielectric layer is greater than 500 V/mil, specifically greater than or equal to 800 V/mil, more specifically greater than or equal to 1,000 V/mil, and still more specifically greater than or equal to 1,500 V/mil.

In addition to the dielectric layer comprising the dielectric material, the circuit material further comprises a conductive layer. The conductive layer is desirably both electrically conducting and thermally conducting. Useful conductive layers for the formation of the circuit materials disclosed herein include stainless steel, copper, nickel plated copper, aluminum, copper-clad aluminum, zinc, zinc-clad copper, iron, transition metals, and alloys comprising at least one of the foregoing, with copper specifically useful. There are no particular limitations regarding the thickness of the conductive layer, nor are there any limitations as to the shape, size or texture of the surface of the conductive layer. In an exemplary embodiment, the conductive layer has a thickness of about 3 micrometers to about 200 micrometers, specifically about 5 micrometers to about 180 micrometers, and more specifically about 7 micrometers to about 35 micrometers. Where two or more conductive layers are present, the thickness of the two layers can be the same or different.

Copper conductive layers are useful. The copper conductive layer can be treated to increase surface area, treated with a stabilizer to prevent oxidation of the conductive layer (i.e., stainproofing), or treated to form a thermal barrier. Both low and high roughness copper conductive layers treated with zinc or zinc alloy thermal barriers are particularly useful, and can further optionally comprise a stain-proofing layer. Such copper conductive layers are available from, for example, Oak-Mitsui under the tradename “TOB,” Circuit Foil Luxembourg under the tradename “TWS,” and Gould Electronics under the tradename “JTCS.” Other suitable copper conductive layers are available from Yates Foil under the trade name “TAX;” from Circuit Foil Luxembourg under the trade name “NT TOR;” from Co-Tech Copper Foil Company under the trade name “TAX;” and from Chang Chun Petrochemical Company under the trade name “PINK.”

In an embodiment, the thermal management circuit material comprises a conductive layer disposed on the dielectric layer. This circuit material can be supplied to a fabricator, for attachment to a surface to provide a pathway for heat dissipation away from the electronic device (e.g., semiconductor device) that is affixed to the conductive layer. Examples of such surfaces include base layers constructed of thermally conductive materials, surfaces of heat sinks, standard circuit boards, and the like. Any suitable means can be used to attach the thermal management circuit material, or a circuit derived therefrom, to the surface. Where it is desirable to attach the thermal management circuit material to the surface, it can be desirable to laminate the thermal management circuit material to the surface, without use of any intervening treatment or layer. In other embodiment, the thermal management circuit material can be attached to a surface using a suitable thermally conducting layer or treatment, such as a thermally conducting adhesive. Such thermally conductive adhesives, where used, can be electrically conductive, semiconducting, or electrically non-conductive. For example, an adhesive comprising a thermosetting material and metallic filler can be used to adhere the thermal management circuit material to a surface, where the metallic filler provides thermal conductivity for the adhesive, but which can render the adhesive electrically conductive. It is understood that such methods of attachment are exemplary for the purpose of illustration, and are not to be considered as limiting thereto.

In another embodiment, the circuit material also comprises a thermally conductive base layer and is provided to the fabricator as such. The thermally conductive base layer is typically significantly thicker than the conductive layer, and comprises a metal having a high thermal conductivity. Suitable metals having such characteristics include aluminum, copper, aluminum clad copper, or other suitable metal or clad metal structure; or engineered thermal materials such as AlSiC, Cu/Mo alloys and the like, are desirable. The thermally conductive base layer can comprise a single layer, multiple layers of a single material, or multiple layers comprising two or more different materials. The thermally conductive base layer can be of a single uniform thickness, or can be of variable thickness. The thermally conductive base layer can include features such as cooling fins, tubes, or have tubes bored through the substrate normal to the plane of the thickness of the substrate layer, through which a coolant can be passed to further increase the transfer of heat. Specifically, the thermally conductive base can itself be a heat sink, where the heat sink can be passively cooled by conducting heat away from the source to diffuse in the mass of the heat sink, or dissipate into a medium such as air by means of structural features with high surface area (e.g., cooling fins); or actively cooled by passing a coolant through by means of a heat transfer surface attached to (e.g. tubes) or located within (e.g., holes bored through) the heat sink.

It is also desirable, for use in combination with high power type solid-state devices, that the circuit material structure as well as individual layers in the circuit material possess thermal properties that can tolerate exposure to temperatures encountered during processing operations such as soldering, brazing and welding. Temperatures of up to about 400° C., in either inert or hydrogen atmospheres, can be encountered. Typically, soldering operations are lower in temperature at about 200° C., while brazing operations can have higher temperatures in excess of about 425° C. Formation of copper oxide as a result of use with these high temperature processes can be mitigated by using a plating of a metal such as nickel, zinc, or other suitable metal can mitigate the formation of oxides on the copper surface.

A method of forming a thermal management materials comprises contacting a conductive layer and a dielectric composition. Alternatively, a dielectric composition is disposed between a conductive layer and a thermally conductive base layer, and pressed to form a laminated structure. The conductive layer is coated with the composition comprising the dielectric composition and particulate filler composition using a slot die coater, curtain coater, roll coater, sprayer, doctor blade, or other suitable coating method. The polymer matrix and particulate filler composition is coated on the conductive layer in an amount so as to obtain a dry thickness of up to about 10 mils (about 250 micrometers). The coated conductive layer can be dried at a temperature of about 30 to about 80° C. after coating, and prior to any contacting with a thermally conductive base layer. In an alternative embodiment, the dielectric composition is coated on the thermally conductive base layer prior to contacting with the conductive layer. In still another embodiment, the particulate filler is contacted with either of the conductive layer, the thermally conductive base layer, or both the conductive layer and thermally conductive base layer prior to contacting with a composition that upon cure and/or lamination yields the dielectric layer. In an embodiment, two or more layers of the dielectric composition can be applied to the same side of the conductive layer, the thermally conductive base layer, or both the conductive layer and thermally conductive base layers. After coating, the polymer matrix layer can also be further thermally treated in an oven at temperatures of about 30 to about 150° C., specifically about 50 to about 90° C., to dry the polymer matrix or, where the a thermosetting resin is used in the polymer matrix, to effect a partial or fall cure, of the dielectric layer prior to contacting with the thermally conductive base layer. In this way, circuit materials can be formed using a batch wise or semi-continuous process, wherein at least one layer of the dielectric material, and any desired additional layers used to form the circuit or multi-layer circuit are arranged in a desired order to form a stack. The stack is then placed in a press, which can or cannot be evacuated to form a vacuum. The temperature is typically increased at a rate of about 2 to about 10° C./minute. Once the temperature reaches the desired lamination temperature the pressure is increased to about 2 to about 3 MegaPascal (MPa). While the desired temperature depends upon the composition of the dielectric composite, the temperature is typically about 200° C. to about 350° C. The stack is held at the desired temperature and pressure for a time sufficient to adhere the layers, about 5 to about 45 minutes. The resulting article is then cooled while maintaining the desired pressure. The article can be removed from the press when the temperature is about 100° C. or lower, and stored until used.

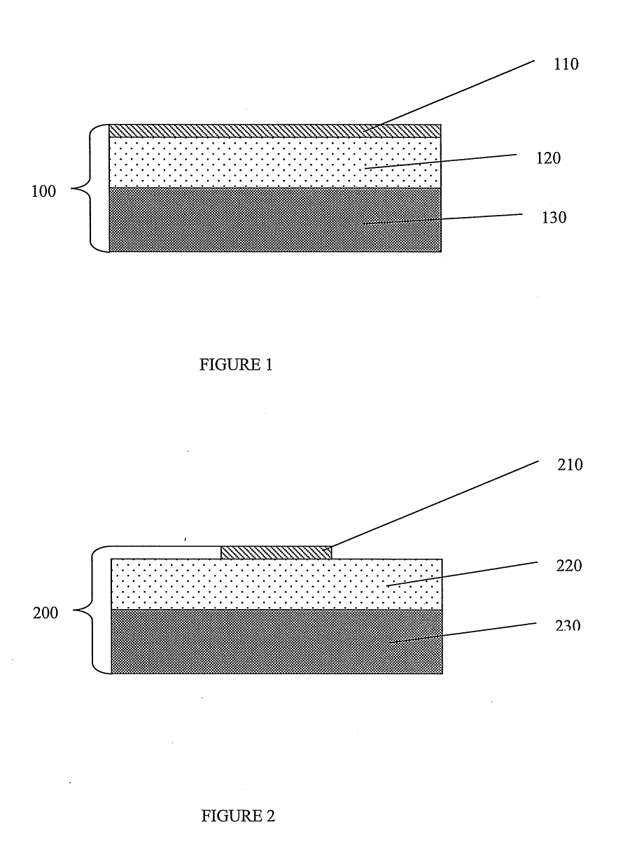

An embodiment of an exemplary diclad circuit material is shown in FIG. 1, wherein a circuit material 100 comprises conductive layer 110 disposed on a dielectric layer 120. As used herein, “disposed on” means in at least partial contact with. Dielectric layer 120 comprises a dielectric material comprising a polymer matrix and particulate filler (not shown). Alternatively, a woven or non-woven thermally conductive fibrous web (not shown) can be used instead of the particulate filler (e.g., a web of carbon fibers), or can be included in addition to the particulate filler (not shown). Optionally, as shown in the embodiment illustrated in FIG. 1, a thermally conductive base layer 130 is disposed on a side of dielectric layer 120 opposite the conductive layer 110. In an embodiment, the thermally conductive base layer 130 is a heat sink (not shown). In a further embodiment, at least one additional layer, for example, a dielectric layer, bond ply, conductive layer, a circuit layer, a circuit, a multilayer circuit, or a combination comprising at least one of the foregoing, can be disposed on circuit material 100 in an appropriate manner to form a multilayer circuit material.

An embodiment of an exemplary circuit is shown in FIG. 2, wherein a circuit 200 comprises circuit layer 210 disposed on dielectric layer 220. Dielectric layer 220 comprises a dielectric material comprising a polymer matrix comprising a polymer and particulate filler (not shown). Alternatively, a woven or non-woven fibrous web can be substituted for or included in addition to the particulate filler (not shown). Optionally, as in the embodiment illustrated in FIG. 2, a thermally conductive base layer 230 is disposed on a side of dielectric layer 220 opposite the circuit layer 210. In an embodiment, the thermally conductive base layer 130 is a heat sink. In a further embodiment, at least one additional layer including a dielectric layer, bond ply, conductive layer, a circuit layer, or a combination comprising at least one of the foregoing, can be disposed on circuit 200 in an appropriate manner to form a multilayer circuit. In a further embodiment, a semiconductor device is mounted on and electrically affixed to the circuit.

In an embodiment, it can also be desirable to include a thermally conductive metallic layer between two or more dielectric layers for heat spreading purposes. The inserted metallic layer can effectively increase or otherwise expand the thermally conductive area through the laminated structure, with this interposed metallic layer thereby functioning primarily as a thermal energy distributing or heat spreader layer for the overall assembly. The rate of heat dissipation for a semiconductor device mounted thereon is accordingly increased.

The circuit materials, circuits, and multi-layered circuits manufactured using the dielectric composite described herein have excellent properties, for example good dimensional stability and enhanced reliability, e.g., plated through-hole reliability, and excellent copper peel strength, particularly at high temperature. In particular the dielectric substrates can have a Dₖ of less than or equal to about 4.5 and a D_{f} of less than or equal to about 0.008 when measured at a frequency of 1 to 10 GHz. They can also have good flame retardance, i.e., a rating of V-1 or better as determined by Underwriter's Laboratory procedure UL-94. They can further have good dimensional stability and structural rigidity. The water absorption can be less than 0.05% at a relative humidity of 50%, specifically at a relative humidity of 90%. Copper bond strength at 200° C. can be greater than about 1 pound per linear inch (pli), specifically greater than about 1.2 pli at 200° C. in both the machine and cross machine directions.

The thermal management circuit materials, and circuits derived therefrom, are useful in the production of substrates for high power applications. Applications include mounting substrates thermal management applications such as heat rail and forming applications for conducting excess heat, as use in automotive, audio, motor control, and power conversion applications; for light emitting diodes (LED), particularly high brightness/high power applications, such as for automotive and other vehicular applications having high power lights such as headlights, tail lights, and running lights; street lights; traffic signal lights; or high power/high brightness visual displays, monitors, readouts, and the like; compact and integrated motor drives; power conversion, specifically DC to DC power conversion modules, such as for hybrid cars; solid state relays, particularly those requiring mechanically tough substrates and mounting configurations not possible with ceramic based modules; and for insulated gate bipolar transistors (IGBT) with applications in high power switching/power management systems, metal-oxide semiconductor (MOS) modules, diode-, thyristor-modules, solid-state-relays for frequency converters, traction controls, welders, traction drives for hybrid cars, household appliances such as washing machines, and the like; sensors and controllers for automotive applications such as airbags, ABS, fuel control, water pump, pressure sensors, and the like; electronic ignition modules; batteries; heat sinks for industrial lasers; power supplies and cooling parts for personal computers; cooling systems for medical lasers; photovoltaics; wind energy alternators, and the like.

The circuit materials disclosed herein are further illustrated by the following non-limiting examples.

The polymer matrix for the dielectric material is prepared using the components listed in Table 1.

TABLE 1

| | | Mitsui |
|---|---|---|
| BN300 | BN300 polyimide | Chemical Co. |
| BN filler | CarboTherm ® Boron Nitride | Saint-Gobain |
| | (plate-type filler) | |
| A1N filler | Aluminum Nitride (A1N) filler | H. C. Starck |
| Cu foil | Copper foil, 2 oz./sq.ft. | — |
| A1 layer | Aluminum substrate | — |

The polymer matrix for use herein is prepared by blending 1 to 95 wt % of BN300, 1 to 99 wt % BN filler, 1 to 99 wt % AlN filler, and less than or equal to 5 wt % additives including adhesion promoter or plasticizer. Solvent is added to dissolve the BN300 and suspend and disperse the particulate fillers. The composition is applied to a 2 ounce/square foot Cu foil using a roll coater, in an amount sufficient to provide a dry thickness (Tks) of 2 to 5 mils (50 to 125 micrometers), and is then thermally treated at 30 to 90° C. for 1 to 60 minutes in an oven to dry off the solvent and other volatiles, and to set the resin composition. A thermal aluminum layer is contacted to the side of the Cu foil having the polymer matrix coated thereon, and the resulting layered structure is laminated in a flat bed press at a temperature of 250 to 300° C. and a pressure of 2 to 3 MPa for 5 to 45 minutes. A circuit material prepared according to this procedure can have the following properties given for Example 1 in Table 2.

TABLE 2

| | | | Max. | | | Thermal | | Dielectric |
|---|---|---|---|---|---|---|---|---|
| | | | Operating | Tks¹ | k² | impedence | CTE | Strength |
| | Supplier | IMS type | Temp (° C.) | (mil) | (W/m-K) | (Tks/k) | (ppm/° C.) | (V/mil) |
| Ex. A* | Denka | Epoxy | 140° C. | 3 | 4 | 0.75 | 67 | 1,000 |
| Ex. B* | Berquist | Polyimide | 140° C. | 3 | 2.2 | 1.4 | 25 | 2,000 |
| Ex. C* | Thermagon | Epoxy | 130° C. | 6 | 3 | 2 | 37 | 800 |
| Ex. D* | Nitto Denko | Epoxy | — | 3.2 | 1 | 3.2 | — | 2,500 |
| Ex. 1 | — | polyimide | ≦250° C. | ≧3 | ≦4 | ≧0.75 | 5-12 | ≦2,000 |

*Comparative

Table 3 illustrates the thermal impedance of a dielectric layer comprising a polyimide-amide resin with different amounts of diamond filler. The polyimide-amide resin was obtained from Toyobo under the trade name Vylomax.

TABLE 3

| | Test | | | | | | Thermal |
|---|---|---|---|---|---|---|---|
| | temp | Pressure | Thermal | Diamond | Thickness | k² | impedance |
| | (° C.) | (PSI/kPa) | lubricant | (wt %) | (mil) | (W/m-K) | (in²K/W) |
| Ex. E* | 50 | 300/2070 | Zn grease | 0 | 0.7 | 0.24 | 0.12 |
| Ex. 2 | 50 | 300/2070 | Zn grease | 40 | 0.6 | 0.30 | 0.077 |
| Ex. 3 | 50 | 300/2070 | Zn grease | 50 | 0.9 | 0.61 | 0.058 |
| Ex. 4 | 50 | 300/2070 | Zn grease | 60 | 0.9 | 0.88 | 0.040 |
| Ex. 5 | 50 | 300/2070 | Zn grease | 70 | 0.8 | 0.66 | 0.048 |
| Ex. 6 | 50 | 300/2070 | Zn grease | 80 | 0.7 | 0.59 | 0.047 |
| Ex. 7 | 50 | 300/2070 | Zn grease | 90 | 3.1 | 1.5 | 0.081 |

*Comparative

The singular forms “a,” “an,” and “the” include plural referents unless the context clearly dictates otherwise. The endpoints of all ranges directed to the same characteristic or component are independently combinable and inclusive of the recited endpoint. All references are incorporated herein by reference. As used herein and throughout, “disposed,” “contacted,” and variants thereof refers to the complete or partial physical contact between the respective materials, substrates, layers, films, and the like. Further, the terms “first,” “second,” and the like herein do not denote any order, quantity, or importance, but rather are used to distinguish one element from another.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

What is claimed is:

1. A thermal management material comprising:
an electrically conductive layer,
a dielectric layer comprising a polymer matrix and a thermally conductive, electrically non-conductive particulate filler,
wherein the dielectric layer is disposed on and in at least partial contact with the electrically conductive layer, and wherein the circuit material has a thermal conductivity of greater than or equal to about 1 watt per meter-degree Kelvin
and further wherein the dielectric layer has a coefficient of thermal expansion of 0 to about 50 parts per million per degree centigrade.

2. The material of claim 1 wherein the dielectric material is thermally stable at a temperature of greater than or equal to about 150° C.

3. The material of claim 1, wherein the polymer matrix comprises a polyetherimide, a polyether ether ketone, a polyimide, an epoxy, a fluoropolymer, a silicone, a polybutadiene, a polyester, a liquid crystalline polymer, or a combination comprising at least one of the foregoing.

4. The material of claim 1, wherein the dielectric layer has a dielectric strength of greater than or equal to 800 volts per mil of thickness.

5. The material of claim 1, wherein the moisture absorption of the polymer matrix is less than or equal to 0.05 percent by weight of the weight of the polymer matrix after exposure to 50 percent relative humidity.

6. The material of claim 1, wherein the particulate filler comprises particles of boron nitride, aluminum nitride, alumina, silicon carbide, zinc oxide, silicon nitride, titanium dioxide, magnesium oxide, aluminum silicate, carbon fibers, carbon nanotubes, beryllium oxide, diamond, or a combination comprising at least one of the foregoing.

7. The material of claim 6, wherein the particulate filler comprises a combination of boron nitride and aluminum nitride.

8. The material of claim 6, wherein the particulate filler is a mixture of particulate fillers.

9. The material of claim 6 wherein the particulate filler has a thermal conductivity of greater than or equal to about 1 W/m-k.

10. The material of claim 6, wherein the particulate filler has a plate-like structure.

11. The material of claim 6, wherein the particulate filler is present in the dielectric layer in an amount of about 1 to about 95 percent by weight, based on the combined weight of the polymer matrix and the filler.

12. The material of claim 1, wherein the dielectric constant of the dielectric layer is less than or equal to about 4.5 when measured at a frequency of 1 to 10 GHz.

13. The material of claim 1, wherein the dissipation factor of the dielectric layer is less than or equal to about 0.008 when measured at a frequency of 1 to 10 GHz.

14. The material of claim 1, wherein the electrically conductive layer is thermally conductive.

15. The material of claim 1, wherein the electrically conductive layer comprises copper, gold, or silver.

16. The material of claim 1, wherein the electrically conductive layer comprises copper.

17. The material of claim 16, wherein the copper is etched in the form of a circuit.

18. The material of claim 1 further comprising a thermally conductive base layer disposed on a side of the dielectric layer opposite the conductive layer.

19. The material of claim 18, wherein the base layer is thermally and electrically conductive.

20. The material of claim 19, wherein the thermally conductive base layer comprises copper, aluminum, aluminum-clad copper, or engineered thermal materials.

21. The material of claim 20, wherein the engineered thermal materials comprise Cu/Mo, AlSiC, or a combination comprising at least one of the foregoing.

22. The material of claim 18, wherein the thermally conductive base layer further comprises cooling fins, cooling tubes, or a combination comprising at least one of the foregoing features.

23. The material of claim 18, wherein the thermally conductive base layer is a heat sink.

24. The material of claim 1 wherein the dielectric layer has a thickness of 1 to 250 micrometers.

25. The material of claim 1 wherein the thermal impedance is less than or equal to 2 mils per W/m-K.

26. An article comprising the material of claim 1.

27. A light emitting diode or insulated gate bipolar transistor comprising the material of claim 1.

28. An article comprising the circuit material of claim 17.

29. A method of making a thermal management material comprising disposing a dielectric composition onto an electrically conductive layer, wherein the dielectric composition comprises a thermally conductive, electrically non-conductive particulate filler and a thermoplastic resin or a curable thermosetting resin, and further wherein the circuit material has a thermal conductivity of greater than or equal to about 1 watt per meter-degree Kelvin.

30. The method of claim 29, further comprising disposing the dielectric composition between the electrically conductive layer and a thermally conductive base layer.

31. The method of claim 29, further comprising laminating the layers.

32. The method of claim 29, comprising partially or fully curing the thermosetting resin after disposing.

33. The method of claim 29, further comprising disposing an additional dielectric layer onto the first dielectric layer.

34. The method of claim 33 wherein the additional dielectric layer is not identical to the first dielectric layer.
